(19) United States
(12) Patent Application Publication
(10) Pub. No.: US 2021/0219534 A1
(43) Pub. Date: Jul. 22, 2021

(54) PROTECTOR FOR ANIMAL HOOVES

(71) Applicant: EVO HORSE S.L, Villaviciosa - Asturias (ES)

(72) Inventors: Florentino PEREIRA SUAREZ, Villaviciosa - Asturias (ES); Jung BERND WERNER, Von-palm-strasse (DE); Albert VILLASEVIL FLORENSA, Cambril - Tarragona (ES)

(21) Appl. No.: 16/310,928

(22) PCT Filed: Aug. 16, 2016
(86) PCT No.: PCT/ES2016/070603

§ 371 Date: Dec. 18, 2018

(51) Int. Cl. A01L 5/00; A01K 13/00; A01L 3/04

(52) U.S. Cl. CPC A01L 5/00; A01L 3/04; A01K 13/007

(57) ABSTRACT

Animal hoof protector, comprising a base (1) coupled onto the animal hoof, having a supporting sole (4); a rear shield (2) closing the base at the back; a protecting skin (3), attached and fixed onto the inner surface of the rear shield; and means for pivotally connecting the rear shield (2) to the base (1),

### FIELD OF THE INVENTION

The present invention refers to a hoof protector for animals, specially intended for being applied to horse hooves, as a convenient, comfortable non-permanent, non-atrophying protection means, and being capable of adapting to any possible situation, without interfering with the natural biomechanics of the animal while moving or in stance, or affecting performance of the inner structures of the equine foot.

### BACKGROUND OF THE INVENTION

The traditional means for protecting horse hooves, which appeared during the Middle Ages and became popular in the Western world from the Industrial Revolution onwards, consist of the classical rigid horseshoes, made of different metal alloys, being fixed to the hoof mainly by means of nails and entailing a permanent protection against wear, with the drawback of being highly atrophying and also showing other side effects that appear in the long-term.

Nowadays, there are attempts to improve this traditional version with the use of flexible and absorbent materials, mainly plastic and rubber which are made from the combination of several components, being reinforced with a metal alloy sheet therein, thus avoiding loss and breakage thereof, and spreading nail vibration onto a bigger surface. Although these last embodiments involve a significant improvement compared to the traditional version thereof, they continue being a permanent support, with all that it involves (overgrowth of the hoof horn due to no wear, occurrence of leverage effect which compromise the soft tissues of limbs, infections of plantar tissues such as the white line and/or the frog, etc.)

On the other hand, both conventional horseshoes and the above mentioned improved version of them, only provide partial hoof protection, particularly against wear of the lower surface thereof. However, they do not protect either the hoof dorsal or front or side surface, or the hoof palmar surface or rear side.

Recently, some non-atrophying solutions have been developed intended to protect both the sole and wall, even protecting the bulbs. In this sense, three different approaches can be cited which are described below.

The first protection approach commonly known as “Glue-ons”, as it can be seen in WO2009142801, US00D685142S, and the Spanish Utility Model ES1072993U, consists of a lower sole which is coupled onto the hoof base, and which can be attached onto the front and side surface of said hoof through an upper wall. These protections use an adhesive to be fixed to the hoof surface, which hinders easy and quick frequent removal thereof.

The second protection approach refers to what is commonly known as “Integral Boots”, to which U.S. Pat. No. 8,291,683B2, US20050072128, A1 U.S. Pat. No. 4,981,010, EP2545771A2, US20050166556A1, U.S. Pat. Nos. 5,715,661A and 6,694,713B1 pertain, consisting of a lower sole being coupled onto the hoof base, an upper wall being coupled to the front and side surface of said hoof, and a third layer of a different material enclosing the upper periphery of protection, above the coronary band of the equine foot and, particularly, around the short pastern bone. These protections remain attached to the hoof in a timely fashion, thus allowing frequent removal in an easy and quick manner. This type of boots, however, feature several important drawbacks:
Firstly, since they are not adaptable, they do not achieve a tight fitting to the equine foot, which causes a double impact during the phase of striking the ground (the boot impacts firstly and then the equine foot), generating high insecurity in the horse.
Secondly, since a tight fitting is not achieved it is easier for them to turn around, especially upon diagonal interference (when a hind foot strikes a forefoot) and/or asymmetric gaits (when a toe reaches the ground with a side before the other).
Third, since they do not achieve a tight fitting, they can generate friction which will end up causing serious galls.
Fourth, as they are so high they interfere with the horse comfort and with the biomechanics of the bottom of the limb, since during the suspension phase movement of the short pastern bone is hindered by the front portion of the protection, while during the stance phase the caudal portion of the protection hinders the long and short pastern bone downward movement.
The fifth inconvenient is that they are very heavy, which may alter acceleration of the lower part of the limb, producing a greater stretching of the limb ligaments.
The sixth inconvenient is that they allow entry of particles of different sizes and, due to the closed design of the protection, these cannot get out, favouring the presence of galls if they are used demandingly and in a prolonged manner.

The third protection approach, refers to what is commonly known as “Sports Boots”, being described in U.S. Pat. No. 4,744,422A, US20110219732A1, U.S. Pat. No. 8,413,412B2, US20130008139A1, U.S. Pat. No. 5,661,958, U.S. D440363, PCT/ES20141070325 and EP2409565A1, comprising a lower sole that couples onto the hoof base, an upper wall that couples onto the front and side surface of said hoof, and a third rear part that couples onto the rear side of the hoof. These protections use different systems so as to remain attached to the hoof in a timely fashion, thus allowing frequent removal, in an easy, quick and comfortable way. The main drawbacks found in the different models making up this type of equine protections or boots are:
None of them can regulate the height of the rear portion thereof in a bilateral or unilateral way, which prevents them from being used in equine feet having higher heels (referred to as club feet).
Due to their indivisible character, they do not allow any adaptation to the animal feet beyond tightening or size selection.
Attachments being used among the different elements are of a non-elastic or totally elastic nature. The former alter the maximum expanding capacity of the soft tissues of the foot during the stance phase, thus altering the comfort of the horse. With the latter being fully elastic, as in PCT ES 2014/070325, although featuring a good adaptability, the excess of elasticity generates friction at sub-cutaneous level, causing occurrence of serious sores in the areas of the foot that feature more mobility, and increasing the risk of loss.
The anchoring elements, strips, Velcro, etc., that the different models comprise, only work in a longitudinal plane, which considerably increases the risk for losing the protection during the suspension phase, since in this phase the horse hoof, when pivoting over its centre, leans the clamps (front area) onto the protection, causing detachment between the lower part of the boot, at the heel height, and the horse hoof. This separation can only be avoided if there is some kind of mechanism that acts on the transverse plane, of which the existing models lack.

### DESCRIPTION OF THE INVENTION

The object of the present invention is to solve the above mentioned problems and to:
Allow three-dimensional deformation of all the elements of the hoof horn, both when the horse is in stance, and when it is performing any type of movement or activity on any type of ground and at any speed.
Provide a protection suitable both against wear and bumps and against any other aggression that can be caused to any part of the animal hoof (front, side, back and lower area).
Allow the correct operation of the inner tissues, thus preventing them from atrophying and promoting their development, functionality and health.
Allow the correct operation of all parts of the limb, avoiding interference with the movement ranges of the different joints and ligaments forming it.
Provide a protector for animal hooves which can adapt to any asymmetry or shape of the hoof in every part thereof (including the bulbs and heels). With that purpose, apart from the design, the protection of the invention is made up of a material which, upon heat application or by any other method, is capable of deforming according to the shape of the hoof, then keeping the obtained shapes thus providing a tight fitting which avoids occurrence of double impacts that generate insecurity, and of empty spaces that increase the risk of losing the boot and generate a leverage effect which can cause unnecessary stress of the limb tissues.
Ensure a compact, flexible and stable attachment among the different components of the protector, so that they provide the animal with a security and comfort feeling, both when not moving and in any phase of the horse gait, but mainly during the hoof suspension and landing.
Prevent debris and liquid from accumulating (water, sweat and any other), by means of a design providing these to go out and enhancing aeration or transpiration thereof, mainly from the areas being beyond the coronary band and highly sensitive to galls.
Avoid the presence of elements that may directly harm the hoof horn and/or the limbs in case of interference.
Provide a protector for horse hooves which features easy and quick mounting and dismounting, and which do not require special strength or knowledge for direct application thereof.
Allow adding additional traction elements widely used under snow conditions and/or in jumping competitions and raid in the open air, known as roughs.
Have an extremely light weight so as to reduce further accelerations of the limb and avoid unnecessary tension in the soft tissues thereof.
Feature anchoring elements or systems that operate diagonally so as to cause an effect both in the longitudinal plane and in the transverse one, thus preventing the boots from being lost.

As it has been indicated above, the protector of the invention is of the type consisting of a base being coupled to the animal hoof, having a lower support sole, a rear shield closing the base at the back, a protecting skin attached to and fixed onto the inner surface of the protecting shield, and also including means for connecting the rear shield to the base.

According to the invention, the sole of the protector base has, from the rear edge to the neighbourhood of the front edge, a longitudinal central area being flexible at the outside, which allows transverse deformation of said sole. According to an embodiment, the sole has at the outside area thereof, a longitudinal central area of a thickness lower than that of said sole, so as to define the elastically flexible longitudinal central area mentioned above. The bottom of this longitudinal central area of the sole of a lower thickness, may be longitudinally crossed by alternate grooves and ribs, thus forming an accordion-like structure that will enable transverse deformation.

According to another characteristic of the invention, the sole of the base will preferably be of a slightly curved configuration, with convexity oriented towards the inner side of the base, so as to cause the enclosure of said base wall over the animal hoof during the gait phase, thus reducing the risk of losing the protection.

The base assembly is intended to be used as a means for protecting the hoof of the animal legs, and is configured in such a way that it can be tightly coupled onto the hoof. To comply with this, the base will be preferably made of a thermoformable material, for example, a thermoplastic material, the purpose of which is to provide the user, by applying heat or by other methods, with a base featuring permanent deformation so as to achieve the perfect adaptation to the geometry of the hoof on which it is to be placed. In order to improve adaptation thereof, the base will have ribs on its wall that will allow opening through holes intended to improve adaptation without risk of breakage. Moreover, the base will feature a different geometry depending on it being intended for the fore or the hind feet of the animal.

The sole of the base forming the protector has, in a preferred embodiment of the invention, two grooves through which corresponding straps pass upwardly, those straps running over inner slots of the sole, and projecting from the rear edge thereof for it to be anchored in buckles which are arranged at the bottom of the protector rear shield.

In the protector of the invention, the rear shield has a central opening which is limited at the upper and lower part thereof by flexible upper and lower stripes. Furthermore, this shield is provided with front, upper and lower extensions, through which said shield is related to the walls of the base.

The front lower extensions of the shield show limited elastic deformation capacity, which increases towards the end of said extensions. This characteristic can be achieved, for example, by reducing the thickness of the front lower extensions in the end portion thereof. For example, said extensions can have, at the inner surface thereof, a central longitudinal slot or recess, along which holes are drilled that are facing holes of the base wall, for anchoring screws to pass through.

The connection means between the rear shield and the base comprise two upper side connectors and two lower side anchoring elements. The upper side connectors are made up of corresponding flexible bands having limited elasticity which are pivotally connected to the upper side extensions of the shield and to the upper connecting areas of the base wall. The lower side anchoring elements consist of at least a screw bolt passing through and fixing each lower front extension of the shield to lower connecting areas of the base wall.

The pivoting connection between the two upper side connectors and the upper side extensions of the shield are made up of a screw bolt.

The upper front extensions of the shield, at the inner surface thereof and in coincidence with the connecting point of the upper side connectors, can be provided with a polygonal slot coinciding with that of the nut being part of the pivoting connection between said upper side connectors and upper front extensions of the shield, thus enabling screwing and tightening between the screw and nut.

Regarding the bands forming the upper side connectors, these have a longitudinal alignment of holes, two of which are selected for being passed through by screws forming the pivotally connections between said bands and the base wall and upper side extensions of the shield. Furthermore, these bands include a closed contour which is elastically deformable by traction, up to a limit point. This closed contour can be located at one of the ends of the bands, and anchored therethrough to locking levers pivotally fixed to the upper connecting areas of the base wall.

The above locking levers may comprise two arms, an upper one and a lower one, both articulated to each other at on the ends thereof. The lower arm is pivotally fixed to the upper connecting area of the base wall. Both arms, at the opposing surfaces thereof, are provided with mutual interlocking conformations, in the closed position, and with a passage for receiving and retaining the band closed contour forming the side connectors.

### BRIEF DESCRIPTION OF THE DRAWINGS

The attached drawings show a non-limiting embodiment, wherein:

FIG. 1 is a front perspective of a horse hoof wearing the protection of the invention.

FIG. 2 is a similar view to FIG. 1 showing an embodiment variant.

FIG. 3 is a rear perspective of the protection mounted in FIG. 2.

FIGS. 4 and 5 are lower and upper perspectives, respectively, of the base of the protection.

FIG. 6 is a perspective exploded view of the rear shield and skin.

FIG. 7 is a front elevated view of the rear shield.

FIG. 8 is a perspective exploded view of the rear shield and skin.

FIG. 9 is a perspective exploded view of the locking lever.

FIG. 10 is a plan view of an upper side connector.

FIG. 11 is a perspective view of the strap connecting the base and the rear shield.

### DETAILED DESCRIPTION OF AN EMBODIMENT

Constitution, characteristics and advantages of the protection of the invention may be better understood with the following description, referring to the embodiment shown in the above listed drawings.

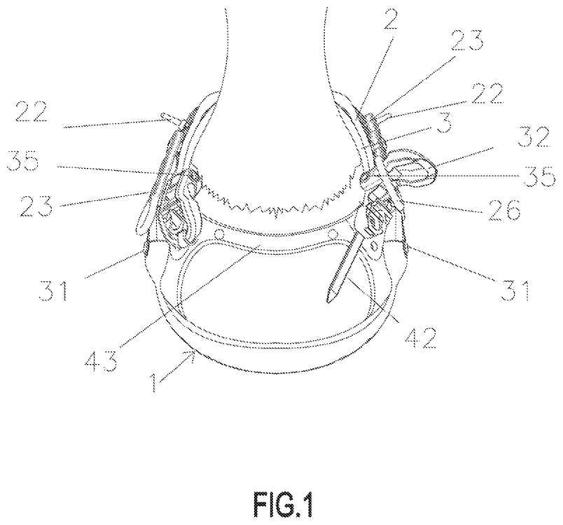

As it can be appreciated in FIGS. 1 to 3, the protector of the invention comprises a base (1), configured to be coupled onto the animal hoof on which is to be mounted, a rear shield (2), closing the base (1) at the rear part thereof, a protecting skin (3) associated with and fixed to the inner surface of the protecting shield, and means for connecting the rear shield (2) to the base (1).

The base (1) will be of an elastically flexible nature, featuring great abrasion resistance and will be preferably made of a thermoformable material, which will enable permanent conformation thereof onto the hoof, by applying heat.

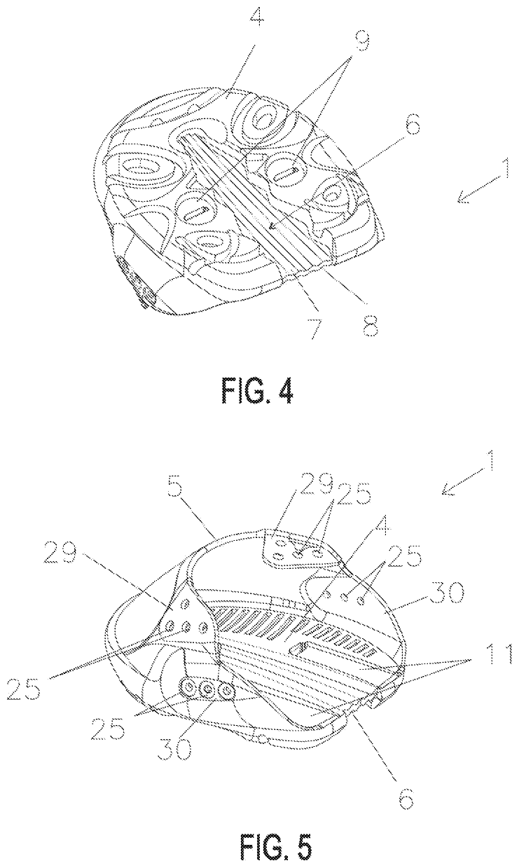

As it can be seen in FIGS. 4 and 5, the base (1) comprises a sole (4) and a side wall (5). The sole (4) is preferably slightly curved, with its concavity oriented inwardly. It is intended for producing the closure of the wall (5) and shield (2) over the animal hoof during the gait phase.

At the outside, the sole (4) has a longitudinal central area (6) of a lower thickness which is elastically flexible in a transverse direction, and it may have an accordion-like structure, having alternate longitudinal grooves (7) and ribs (8), thus providing the protector with a flexibility that allows it to adapt to all natural deformations which are produced in the hoof horn of the animal hoof during the different gait phases.

The wall (5) surrounds the sole along the front and side edges thereof, being also possible for it to be partially surrounded at its rear edge.

In the sole (4) two through grooves (9) are drilled through which corresponding toothed straps (10) are introduced, FIG. 11, running over the inner side of the sole along the slots (11), FIG. 5, from which these project for being attached to the rear shield (2), as it will be set forth below.

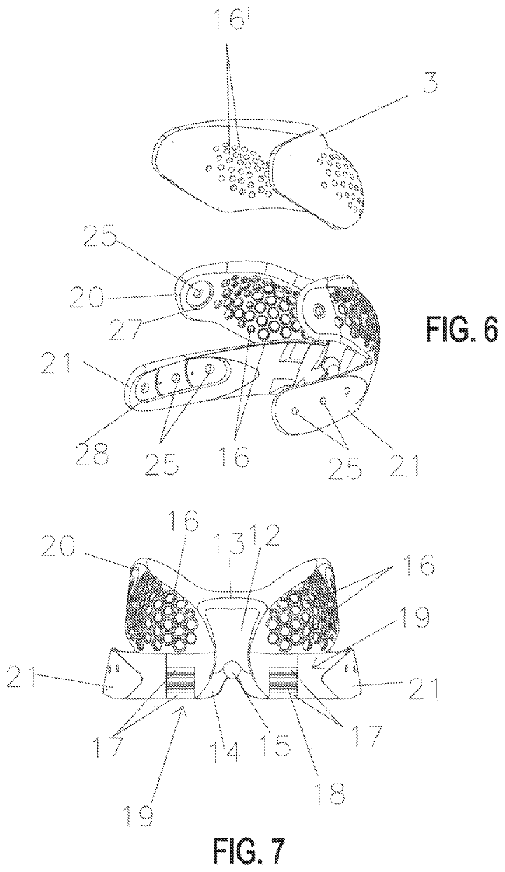

The rear shield (2), FIGS. 6 and 7, is designed for fitting to and covering the rear hoof of the animal, and it comprises a wall having a central opening (12), being limited by an upper stripe (13) and a flexible lower stripe (14) flexible, the upper one (13) preferably featuring a circular section, and the lower one (14) having an upward angular layout and being finished by a spherical broadening (15) at the vortex. The rest of the shield wall have air vents (16). Inside, the wall of the rear shield has two pairs of passages (17), located at both sides of the central opening (12), with a cogged portion (18) between them, configuring buckles through which cogged straps (10) are introduced and fixed. The wall of the rear shield is also provided with upper (20) and lower (21) front extensions, through which the shield is related to the base walls by pivotally connecting means. The lower front extensions (21) will preferably be of flexible and slightly elastic nature, for example, by reducing thickness thereof.

The skin (3) is attached and fixed onto the inner surface of the rear shield, for example by means of elastic rivets (22), FIGS. 1 to 3, introduced through coinciding holes of both components. This skin is also provided with air vents (16′).

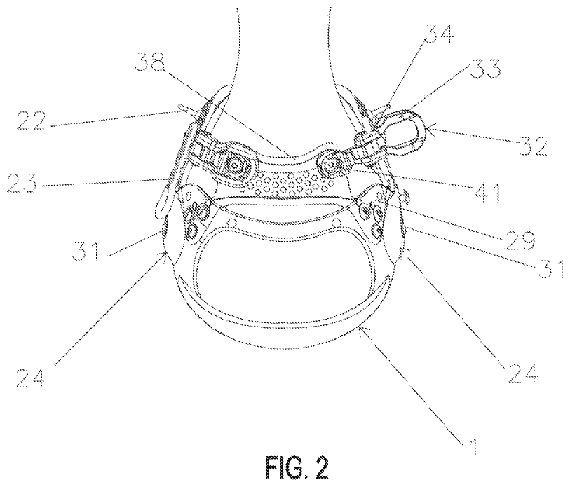

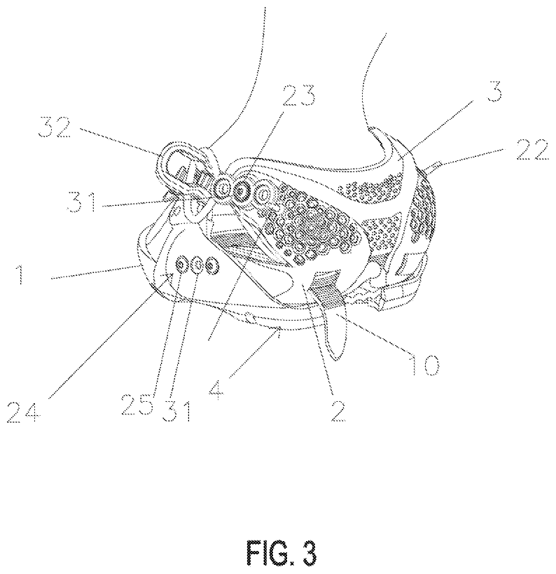

The rear shield (2) relates to the base wall through two upper side connectors (23) and two lower side anchoring elements (24), FIGS. 2 and 3.

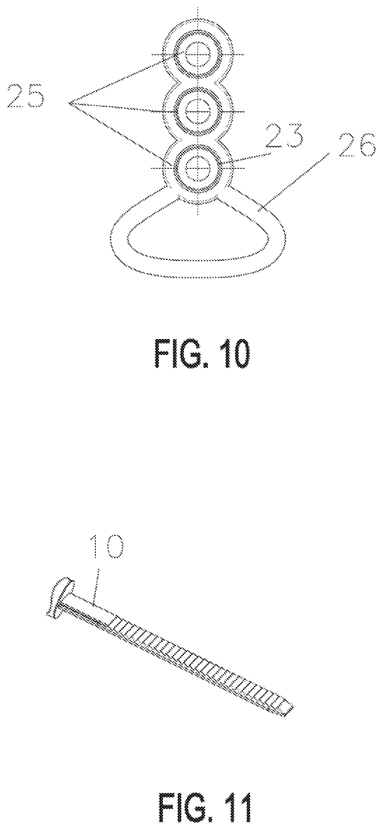

The upper side connectors (23), FIG. 10, consist of bands of an elastically flexible nature, having a longitudinal alignment of connecting holes (25) and an end or intermediate closed contour (26).

The upper front extension (20) of the rear shield (2) also have, FIG. 6, a connecting hole (25) from the bottom of an inner slot (27) featuring a polygonal contour, in which a nut is housed, not shown, wherein a screw defining a pivoting connection is screwed.

The lower front extension (21) of the rear shield (2) is also provided, FIG. 6, with an alignment of connecting holes (25) from the bottom of a longitudinal slot (28) having said extensions inside.

In turn, the base wall (1) has, FIG. 5, upper connecting areas (29) having connecting holes (25), and lower connecting areas (30), also with connecting holes (25).

With the constitution described, the rear shield (2) is associated to the base wall (1) through pivoting connections made up of a screw (31), FIGS. 1 to 3, introduced through connecting holes (25) being selected from the lower front extension (21) of the shield (2), FIG. 6, and the lower connecting area (30) of the base wall, FIG. 5, on one side. On the other side, the upper side connectors (23) are connected, FIG. 3, also pivotally, by means of a screw (31) introduced through one of the connecting holes (25), FIG. 10, of said connectors, and the connecting hole (25) of the upper front extension (20) of the rear shield (2), FIG. 6. Through the closed contour (26), the upper side connectors (23), FIG. 10, are connected to locking levers (32), FIGS. 1 to 3.

These locking levers (32), as shown in FIG. 9, comprise an upper arm (33) and a lower arm (34), articulated to each other at one end through a pin (35). The lower arm (34) has a connecting hole (25) which faces one of the connecting holes (25) of the upper connecting area (29), FIG. 5, of the base (1), for a connecting screw to pass through, not shown, which constitutes a pivoting attachment or connection between the locking lever (32) and the base (1).

The upper (33) and lower (34) arms have, at the opposing surface thereof, FIG. 9, conformations (36) for their mutual interlocking, upon attaching both arms. They are also provided, also the upper arm (33), with a passage (37) intended to receive the rib forming the closed contour (26) of the upper side connector (23), FIG. 10, for holding it.

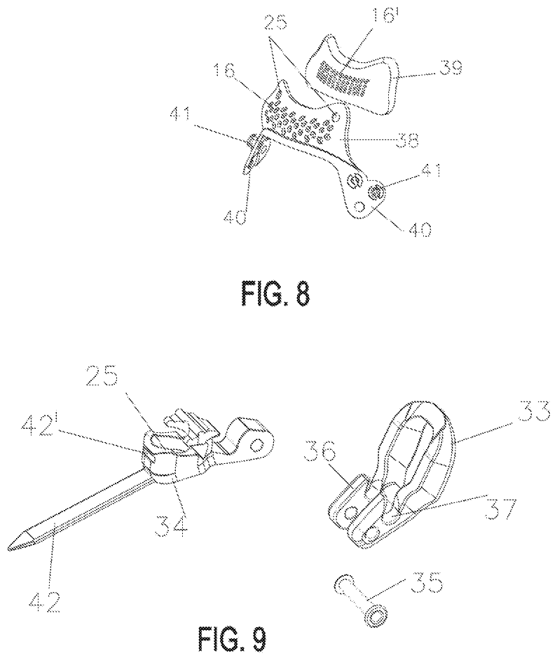

As it is shown in FIG. 2, the protector can also include a front shield (38), to the inner surface of which a front skin (39) is attached and fixed, FIG. 8, similarly to the arrangement described for the rear shield (2). This front shield is configured for coupling and fixing, at a side thereof, to the base wall, and for fixing to the locking lever (32), as it is shown in FIG. 2. For that, the front shield (38) is provided with lower extensions (40) carrying rivets (41) which are introduced through the connecting holes (25) of the upper connecting area (29), FIG. 5, of the base (1). Near the upper edge, this front shield (38) is provided with two connecting holes (25′) for fixing by means of screws (41) of the lower arm (34) of the locking lever (32). Both the front shield (38) and the front skin (39) are provided with air vents (16-16′) on its wall.

The locking lever (32), FIG. 9, may be provided, as an extension of the lower arm (34), of a strip (42) being introduced through the groove (42″), so as to secure the closing position, wherein both arms, upper (33) and lower (34), are attached and anchored through the conformations (36).

All the components described will be preferably made of thermoplastic materials, which provide certain flexibility to said components.

The front (39) and rear (3) skins will be breathable and having anti-frictional wear, made of, for instance, neoprene or materials with similar characteristics.

1.-13. (canceled)

14. An animal hoof protector, comprising a base coupled onto the animal hoof, having a lower supporting sole; a rear shield closing the base at the back; a protecting skin, attached and fixed onto the inner surface of the rear shield; and means for connecting the rear shield to the base, wherein:
the sole of the base has, from the rear edge and up to the neighbourhood of the front edge, an elastically flexible longitudinal central area, which allow transverse deformation of said sole;
the rear shield has a central opening which is limited at the upper and lower part thereof by a flexible upper stripe and lower stripe, and is provided with upper and lower front expansions, through which said shield is related to the walls of the base;
the connecting means between the rear shield and base comprise two upper side connectors and two lower anchoring elements; whose upper side connectors comprise corresponding flexible bands featuring limited elasticity, which are pivotally connected to upper front extensions of the shield and to upper connecting areas of the wall of the base, and whose lower side anchoring elements consist of at least one screw bolt passing through and fixing each lower front extension of the shield to lower connecting areas of the base wall,
wherein the sole of the base has in the outer area, a longitudinal central area of a lower thickness than said sole so as to define the flexible longitudinal central area, the bottom of the longitudinal central area of the sole of lower thickness is longitudinally crossed by alternate grooves and ribs, the sole of the base has a curved configuration, with convexity oriented towards the inner side of the base, and the stripe that limits at the lower part thereof, the central opening of the shield, follows an upward angular layout, and is riveted by a spherical broadening on the vortex.

15. The animal hoof protector according to claim 14, wherein the base is made of a thermoformable material.

16. The animal hoof protector according to claim 14, wherein the wall of the base is grooved with ribs which allow a better adaptation by opening through holes without this is compromised.

17. The animal hoof protector according to claim 14, wherein the sole of the base has two grooves through which straps pass through upwardly, running over inner slots, and projecting from the rear edge thereof to be anchored in buckles configured in the lower part of the rear shield, at both sides of the central opening of said shield.

18. The animal hoof protector according to claim 14, wherein the lower front extensions of the shield feature limited deformation elastic capacity, increasing towards the end of said extension.

19. The animal hoof protector according to claim 14, wherein the lower front extensions of the shield have, at the inner surface thereof, a longitudinal slot through which holes facing holes of the base wall are drilled for the screw or screw nuts to pass through, defining the lower side anchoring elements between the rear shield and the base wall.

20. The animal hoof protector according to claim 14, wherein the wall of the rear shield is provided, at both sides of the central opening, with air vents.

21. The animal hoof protector according to claim 14, wherein the pivoting connection between upper side connectors and upper front extensions of the shield consists of a screw and a nut.

22. The animal hoof protector according to claim 14, wherein the upper front extensions of the shield have, at the inner surface thereof and in coincidence with the connecting point with the upper side connectors, an inner slot, of a polygonal contour, coinciding with that of the nut being part of the pivoting connection between said upper side connectors and upper front extensions of the shield.

23. The animal hoof protector according to claim 14, wherein the bands forming the upper side connectors have a longitudinal alignment of connecting holes, two of which are selected for being passed through by screws forming the pivotally connections between said bands and the base wall and upper side extensions of the shield, and a closed contour elastically deformable by traction.

24. The animal hoof protector according to claim 23, wherein the closed contour is located at one of the ends of the upper side connectors and through said contour it anchors to locking levers being pivotally fixed to upper connecting areas of the wall of the base.

25. The animal hoof protector according to claim 14, wherein the locking levers comprise two arms, an upper one and a lower one, articulated to each other at one of their ends by means of a pin, whose lower arm is pivotally fixed to the upper connecting area of the base wall, and whose upper and lower arms are provided, at facing surfaces thereof, with mutual interlocking conformations in its closed position, and a passage for receiving and retaining the closed contour of the band forming the upper side connectors

26. The animal hoof protector according to claim 14, further comprising a front shield which is anchored at the lower part thereof by means of screws to the base wall and defining the upper areas to which the upper side connectors are pivotally connected.
